(19) United States
(12) Patent Application Publication
(10) Pub. No.: US 2010/0077075 A1
(43) Pub. Date: Mar. 25, 2010

(54) Network Diagnostic Systems and Methods for Collecting Data From Network Nodes

(75) Inventors: Genti Cuni, Mountain View, CA (US); Jay Steven Nitikman, Santa Cruz, CA (US); Andrea Mayumi Nagao, Santa Cruz, CA (US); Ricardo A. Negrete, Scotts Valley, CA (US)

Correspondence Address: Workman Nydegger;1000 Eagle Gate Tower, 60 East South Temple, Salt Lake City, UT, 84111, US

(73) Assignee: VIRTUAL INSTRUMENTS CORPORATION, Scotts Valley, CA (US)

(21) Appl. No.: 12/361,250

(22) Filed: Jan. 28, 2009

Related U.S. Application Data
(60) Provisional application No. 61/024,406, filed on Jan. 29, 2008.

(51) Int. Cl. G06F 15/16

(52) U.S. Cl. 709/224

(57) ABSTRACT

A system may comprise a network diagnostic device. The network diagnostic device may be configured to instantiate objects of data collection classes. The data collection classes may be configured to collect data from nodes of a network. The data collection classes may, for instance, inherit an interface object from an ancestor data collection class, and the interface object may be configured to use a protocol to collect data from nodes of a network. The network diagnostic device may be configured to automatically detect a node type associated with a node of a network. The network diagnostic device may also be configured to instantiate a node-specific data collection object associated with the detected node type. The node-specific data collection object may be configured to collect data from nodes of the detected node type at intervals less than or equal to fifteen seconds.

### CROSS-REFERENCE TO RELATED APPLICATIONS

This application claims the benefit of U.S. Provisional Patent Application Ser. No. 61/024,406 entitled NETWORK DIAGNOSTIC SYSTEMS AND METHODS FOR COLLECTING DATA FROM NETWORK NODES, filed Jan. 29, 2008, and incorporated herein in its entirety by this reference.

### BACKGROUND OF THE INVENTION

1. The Field of the Invention

The present invention generally relates to network diagnostic systems and methods and, in particular, network diagnostic systems and methods for collecting data from network nodes.

2. The Relevant Technology

Computer and data communications networks continue to proliferate due to declining costs, increasing performance of computer and networking equipment, and increasing demand for communication bandwidth. Communications networks—including wide area networks (“WANs”), local area networks (“LANs”), metropolitan area networks (“MANs”), and storage area networks (“SANs”)—allow increased productivity and use of distributed computers or stations through the sharing of resources, the transfer of voice and data, and the processing of voice, data and related information at the most efficient locations. Moreover, as organizations have recognized the economic benefits of using communications networks, network applications such as electronic mail, voice and data transfer, host access, and shared and distributed databases are increasingly used as a means to increase user productivity. This increased demand, together with the growing number of distributed computing resources, has resulted in a rapid expansion of the number of installed networks. A variety of network diagnostic systems and methods have been developed to test these networks.

### BRIEF SUMMARY OF THE INVENTION

One aspect is a system that may comprise a network diagnostic device that may be configured to instantiate objects of any of a plurality of data collection classes. The plurality of data collection classes may inherit an interface object from an ancestor data collection class. The interface object may be configured to use a first protocol to collect data from nodes of a network. The first plurality of a data collection classes may comprise a first node-specific data collection class configured to use the inherited interface object to collect data from nodes of a first node type; and a second node-specific data collection class configured to use the inherited interface object to collect data from nodes of a second node type.

Another aspect is a system that may comprise a network diagnostic device configured to automatically detect a node type associated with a node of a network. The network diagnostic device may also be configured to instantiate a node-specific data collection object associated with the node type. The node-specific data collection object may be configured to collect data from nodes of the node type.

Yet another aspect is a system that may comprise a network diagnostic device configured to automatically detect a node type associated with a node of a network. The network diagnostic device may also be configured to instantiate a node-specific data collection object associated with the node type. The node-specific data collection object may be configured to collect data from nodes of the node type at intervals less than or equal to fifteen seconds.

For purposes of summarizing, some aspects, advantages and features of a few of the embodiments of the invention have been described in this summary. Some embodiments of the invention may include some or all of these summarized aspects, advantages and features. However, not necessarily all of (or any of) these summarized aspects, advantages or features will be embodied in any particular embodiment of the invention. Thus, none of these summarized aspects, advantages and features are essential. Some of these summarized aspects, advantages and features and other aspects, advantages and features may become more fully apparent from the following detailed description and the appended claims.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 is a block diagram of an exemplary system;

FIG. 2 is a block diagram of an exemplary object model;

FIG. 3 is a flowchart illustrating an exemplary method; and

FIG. 4 is a block diagram of a portion of the system shown in FIG. 1.

### DETAILED DESCRIPTION OF THE PREFERRED EMBODIMENTS

Certain embodiments relate generally to networking systems, including the testing of high speed data transmission systems and components. Embodiments of the invention may be used in other contexts unrelated to testing systems and components and/or in other contexts unrelated to high speed data transmission.

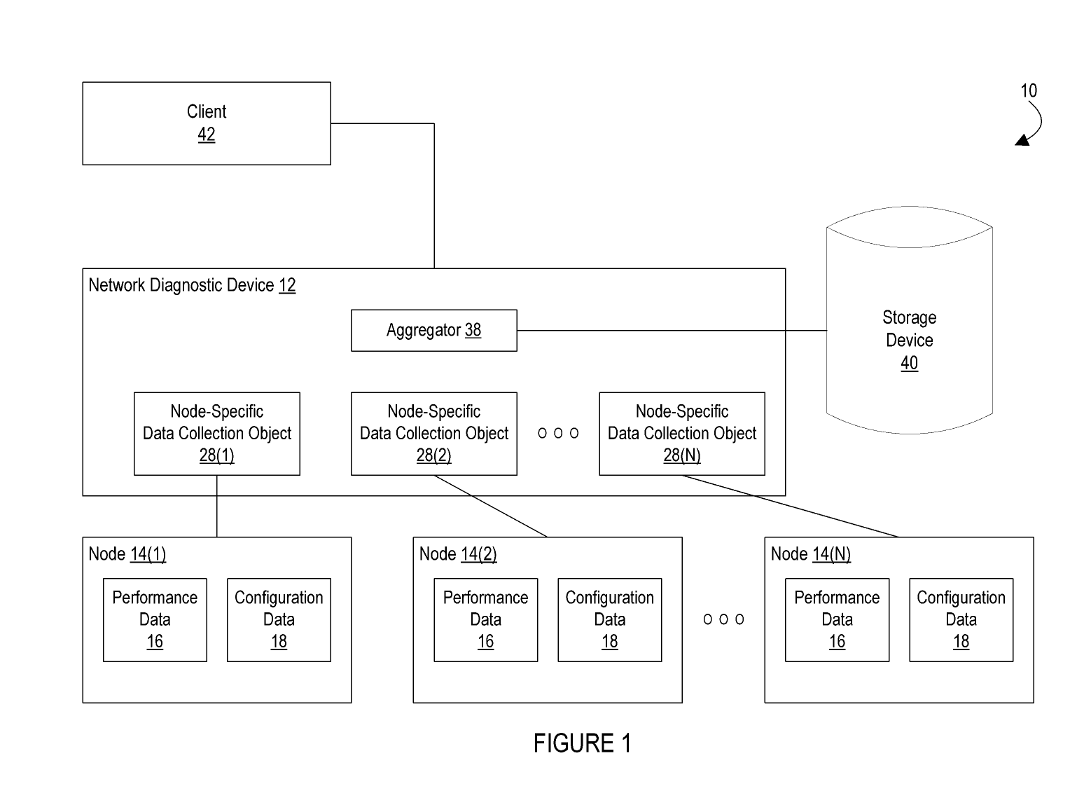

The networking system 10 shown in FIG. 1 may comprise a network, a network diagnostic system, and/or any other suitable networking system. The networking system 10 may include one or more nodes. As used herein, a “node” includes, but is not limited to, a server or host; a client or storage device; a switch (such as a physical layer switch or other type of switch); a hub; a router; all or a portion of a SAN fabric; a diagnostic device; and any device that may be coupled to a network and that may receive and/or monitor a signal or data over at least a portion of a network, that may send and/or generate a signal or data over at least a portion of a network, or both.

The nodes may use a signal (such as, an optical signal) to send and/or receive network messages over at least a portion of the networking system 10. As used herein, a “network message” includes, but is not limited to, a packet; a datagram; a frame; a data frame; a command frame; an ordered set; any unit of data capable of being routed (or otherwise transmitted) through a network; and the like. In one embodiment, a network message may comprise transmission characters used for data purposes, protocol management purposes, code violation errors, and the like. Also, an ordered set may include, a Start of Frame (“SOF”), an End of Frame (“EOF”), an Idle, a Receiver_Ready (“R_RDY”), a Loop Initialization Primitive (“LIP”), an Arbitrate (“ARB”), an Open (“OPN”), and Close (“CLS”)—such as, those used in certain versions of Fibre Channel. Of course, any ordered sets and/or any network messages of any other size, type, configuration and/or protocol may be used.

The nodes may communicate using any suitable network protocol, including, but not limited to, serial protocols, physical layer protocols, channel protocols, packet-switching protocols, circuit-switching protocols, Ethernet, Fast Ethernet, Gigabit Ethernet, 10 Gigabit Ethernet, Fibre Channel, Fibre Channel Arbitrated Loop (“FC-AL”), Small Computer System Interface (“SCSI”), High Performance Parallel Interface (“HIPPI”), Serial Attached SCSI (“SAS”), Serial ATA (“SATA”), SAS/SATA, Serial SCSI Architecture (“SSA”), and the like.

As shown in FIG. 1, the networking system 10 may include a network diagnostic device 12 that may be configured to test the communication between the nodes. For example, the networking system 10 may include one or more nodes 14, which may store and/or maintain data, such as performance data 16, configuration data 18 and/or other data relating to such communication. The diagnostic device 12 may be configured to instantiate objects of any of a plurality of data collection classes to collect the data stored and/or maintained by the nodes 14.

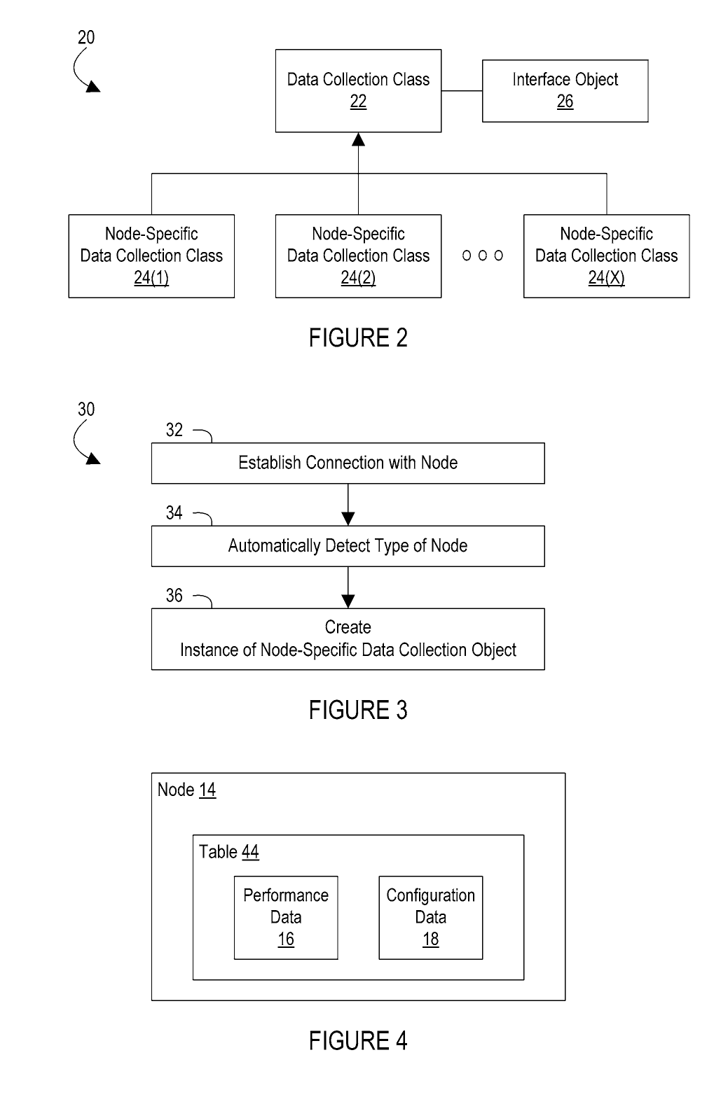

In further detail, as shown in FIG. 2, an object model 20 may include one or more classes, such as data collection classes 22, 24. The data collection class 22 may include an interface object 26 as an attribute, and the interface object 26 may be configured to use a protocol to collect data from nodes of a network. For example, the interface object 26 may be configured to use Simple Network Management Protocol (SNMP) or any other suitable protocol to collect the performance data 16, the configuration data 18 and/or other data relating to node communication.

As shown in FIG. 2, the data collection class 22 may be a parent or other ancestor class to the child or descendant data collection classes 24. Thus, the data collection classes 24 may inherit one or more attributes and/or other features from the data collection class 22. For example, the data collection classes 24 may inherit the interface object 26 from the data collection class 22 and may use the inherited interface object 26 to collect the performance data 16, the configuration data 18 and/or other data relating to node communication.

Significantly, the data collection classes 24 may be node-specific data collection classes configured to collect data from different types of nodes. The node-specific data collection classes may, for instance, be configured to use the inherited interface object 26 to collect data from nodes of different types of nodes. For example, the data collection classes 24 may include a first node-specific data collection class 24 and a second node-specific data collection class 24. The first node-specific data collection class 24 may be configured to use the inherited interface object 26 to collect data from nodes of a first node type; and the second node-specific data collection class 24 may be configured to use the inherited interface object 26 to collect data from nodes of a second node type.

Thus, in one such instance, the first node-specific data collection class 24 may be a first switch-specific data collection class configured to use the inherited interface object 26 to collect data from switches of a first switch type, and the second node-specific data collection class 25 may be a second switch-specific data collection class configured to use the inherited interface object 26 to collect data from switches of a second switch type. In another such instance, the first node-specific data collection class 24 may be a first switch-specific data collection class configured to use the inherited interface object 26 to collect data from switches of a first switch type, and the second node-specific data collection class 24 may be a first storage-device-specific data collection class configured to use the inherited interface object 26 to collect data from storage devices of a first storage device type. In yet another such instance, the first node-specific data collection class 24 may be a first storage-device-specific data collection class configured to use the inherited interface object 26 to collect data from storage devices of a first storage device type, and the second node-specific data collection class 24 may be a second storage-device-specific data collection class configured to use the inherited interface object 26 to collect data from storage devices of a second storage device type. The data collection classes 24, however, may include any number of node-specific data collection classes 24 that may be configured to use the inherited interface object 26 to collect data from any number and/or combination of different types nodes including, but not limited to, servers or hosts, clients or storage devices, switches (such as physical layer switches or other type of switches), hubs, routers and/or other types of nodes.

As shown in FIG. 1, the network diagnostic device 12 may be configured to instantiate one or more objects 28 of some or all of the data collection classes 24. For example, the network diagnostic device 12 and/or one or more other components of the networking system 10 may be configured to perform all or at least a portion of a network diagnostic method 30 shown in FIG. 3. In particular, the network diagnostic device 12 may, at block 32, establish a connection with a node 14; may, at block 34, automatically detect a node type associated with the node 14; and may, at block 36, instantiate a node-specific data collection object 28 associated with the node type, the node-specific data collection object 28 being configured to collect data from nodes of the node type. In particular, at block 36, the network diagnostic device 12 may identify a node-specific data collection class 24 that is associated with the node type that was detected at block 34 and then may instantiate a node-specific data collection object 28 of the identified class. In some embodiments, to automatically detect the node type associated with the node at block 34, the network diagnostic device 12 may establish a connection with the node; receive a plurality of characters from the node (such as, characters configured to be displayed on a screen as at least part of a TELNET prompt or other type of prompt); and use the received plurality of characters to identify a node type associated with the node. In particular, the network diagnostic device 12 may perform a “screen scrape” and may parse the screen scrape to identify a node type associated with the node.

In some embodiments, a node's World Wide Name (WWN) may be used to identify the manufacturer of the node, which in turn may be used to infer that the node is of a particular type. For example, the network diagnostic device 12 may, at block 34, use a node's WWN to identify the manufacturer of the node and automatically infer that the device is of a particular type, and the network diagnostic device 12 may, at block 36, instantiate a node-specific data collection object 28 associated with the inferred node type. For instance, if the manufacturer is primarily a manufacturer of storage devices, the network diagnostic device 12 may, at block 34, automatically infer that the node is a storage device and may, at block 36, instantiate a node-specific data collection object 28 associated with storage devices generally or, if desired, storage devices manufactured by that particular manufacturer. If this auto-detection is not correct, a user may reconfigure the network diagnostic device 12 to instantiate a node-specific data collection object 28 associated with the correct type of node.

As shown in FIG. 1, the network diagnostic device 12 may include an aggregator 38. The aggregator 38 may be configured to receive the performance data 16, the configuration data 18 and/or other data relating to node communication collected by the data collection objects 28 and may aggregate that data, for example, according to a desired interval of time (such as every minute, every five minutes, etc.). The network diagnostic device 12 may store the aggregated data in a storage device 40, for example, in a database stored on the storage device. The network diagnostic device 12 may also provide the aggregated data in real time to a client 42, which may present various views of the real time data. For example, the network diagnostic device 12 may comprise a first computing device (such as a server) that may provide the aggregated data in real time to a second computing device (such as, the client 42). If desired, the network diagnostic device 12 may retrieve the aggregated data in the storage device 40, reaggregate it for a larger interval of time (such as, hourly, daily, weekly, etc.) and store the reaggregated data in the storage device 40. In response to a request from the client 42, the network diagnostic device 12 may also provide, to the client, the aggregated and/or reaggregated data stored in the storage device 40 for use in reporting.

In some embodiments, the data collection classes 24 may advantageously be configured to periodically collect data from nodes 14 at relatively small intervals, such as intervals less than or equal to fifteen seconds. In particular, as discussed below, the data collection classes 24 may use the inherited interface object 26 to quickly and easily collect this data such relatively small intervals. Of course, the data collection classes 24 may be configured to collect data from nodes in any other suitable manner and/or at smaller or larger intervals, if desired.

As shown in FIG. 4, a node 14 may include a table 44 in which performance data 16, configuration data 18 and/or other data relating to node communication may be stored. In some instances, the interface object 26 may be configured to use SNMP to quickly and easily collect the data in the table 44 by requesting data in a bulk fashion or in a row-by-row fashion. Of course, the interface object 26 may be configured to use any other suitable protocol to collect the data in the table 44 and may request the data in any other suitable fashion. Moreover, the data collection classes 24 need not use the inherited interface object 26 to collect data from these nodes depending, for example, upon the particular configuration of the data collection classes 24. Finally, the nodes 14 do not require a table 44 and may store the performance data 16, configuration data 18 and/or other data relating to node communication using any other suitable means.

As mentioned above, a node 14 may store and/or maintain data, such as performance data 16, configuration data 18 and/or other data relating to node communication. For example, a node 14 may be a switch that may store and/or maintain performance data 16, such as Class3Discards, InvalidCRC, LinkFailures, LossOfSignal, LossOfSynchronization, ReceivedBytes, ReceiveLinkResets, ReceivedFrames, TransmittedBytes, TransmitLinkResets, TransmittedFrames, and/or other performance data 16. Also, for example, a node 14 may be a switch that may store and/or maintain configuration data 18, such as port configuration data (e.g., the port's World Wide Name (WWN); the port's speed; the port's port type, such as NPort, FPort, EPort, etc.); node configuration data for nodes connected to a port (e.g., the connected node's WWN; the connected node's FCID); and/or other configuration data. The node 14, of course, need not be a switch and may store and/or maintain any other suitable data.

The methods and systems described above require no particular component or function. Thus, any described component or function—despite its advantages—is optional. Also, some or all of the described components and functions described above may be used in connection with any number of other suitable components and functions.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system comprising:
a network diagnostic device configured to instantiate objects of any of a plurality of data collection classes, the plurality of data collection classes inheriting an interface object from an ancestor data collection class, the interface object configured to use a first protocol to collect data from nodes of a network, the first plurality of a data collection classes comprising:
a first node-specific data collection class configured to use the inherited interface object to collect data from nodes of a first node type; and
a second node-specific data collection class configured to use the inherited interface object to collect data from nodes of a second node type.

2. The system as in claim 1, wherein the first node-specific data collection class comprises a first switch-specific data collection class configured to use the inherited interface object to collect data from switches of a first switch type; and
wherein the second node-specific data collection class comprises a second switch-specific data collection class configured to use the inherited interface object to collect data from switches of a second switch type.

3. The system as in claim 1, wherein the first node-specific data collection class comprises a first switch-specific data collection class configured to use the inherited interface object to collect data from switches of a first switch type; and
wherein the second node-specific data collection class comprises a first storage-device-specific data collection class configured to use the inherited interface object to collect data from storage devices of a first storage device type.

4. The system as in claim 1, wherein the first node-specific data collection class comprises a first storage-device-specific data collection class configured to use the inherited interface object to collect data from storage devices of a first storage device type; and
wherein the second node-specific data collection class comprises a second storage-device-specific data collection class configured to use the inherited interface object to collect data from storage devices of a second storage device type.

5. The system as in claim 1, wherein the first protocol is SNMP.

6. The system as in claim 1, wherein the first node-specific data collection class is configured to use the inherited interface object to collect performance data and/or configuration data from nodes of the first node type; and wherein the second node-specific data collection class is configured to use the inherited interface object to collect performance data and/or configuration data from nodes of the second node type.

7. The system as in claim 1, wherein the first node-specific data collection class is configured to use the inherited interface object to periodically collect performance data and/or configuration data at intervals less than or equal to fifteen seconds; and wherein the second node-specific data collection class is configured to use the inherited interface object to periodically collect performance data and/or configuration data at intervals less than or equal to fifteen seconds.

8. A system comprising:
a network diagnostic device configured to automatically detect a node type associated with a node of a network and to instantiate a node-specific data collection object associated with the node type, the node-specific data collection object configured to collect data from nodes of the node type.

9. The system as in claim 8, wherein the network diagnostic device is configured to automatically detect the node type associated with the node by:
establishing a connection with the node;
receiving a plurality of characters from the node; and
using the received plurality of characters to identify a node type associated with the node.

10. The system as in claim 9, wherein the received plurality of characters are configured to be displayed on a screen as at least part of a prompt.

11. The system as in claim 9, wherein the received plurality of characters are configured to be displayed on a screen as at least part of a TELNET login prompt.

12. The system as in claim 8, wherein the node-specific data collection object is configured to collect performance data and/or configuration data from nodes of the node type.

13. The system as in claim 8, wherein the node-specific data collection object is configured to periodically collect performance data and/or configuration data at intervals less than or equal to fifteen seconds.

14. The system as in claim 8, wherein the node is a switch; and wherein the node type is a switch type.

15. A system comprising:
a network diagnostic device configured to automatically detect a node type associated with a node of a network and to instantiate a node-specific data collection object associated with the node type, the node-specific data collection object configured to collect data from nodes of the node type at intervals less than or equal to fifteen seconds.
